(19) United States
(12) Patent Application Publication
(10) Pub. No.: US 2002/0131405 A1
(43) Pub. Date: Sep. 19, 2002

(54) Java based information exchange process and system thereof

(76) Inventors: Ching-Fang Lin, Simi Valley, CA (US); Qingye Jiang, Simi Valley, CA (US)

Correspondence Address: DAVID AND RAYMOND PATENT GROUP, 1050 OAKDALE LANE, ARCADIA, CA, 91006, US

(21) Appl. No.: 10/077,039

(22) Filed: Feb. 14, 2002

Related U.S. Application Data
(60) Provisional application No. 60/269,039, filed on Feb. 14, 2001.

(51) Int. Cl. H04L 12/28

(52) U.S. Cl. 370/352; 370/389

(57) ABSTRACT

A method and system for remote data acquisition and processing, remote device control and configuration, information sharing between multiple devices (instruments and facilities), and remote device maintenance and upgrading. In fact, the networked devices (instruments and facilities) can be turned into nodes of information source in the Internet, and the information accumulated by these devices (instruments and facilities) is accessible to commercial applications via the Internet. Under this innovative structure each device (instrument and facility) supports the unique interface: Java. All functional modules take the form of a Java class, and are highly modularized. By downloading the latest functional module from the manufacturer's web site, the function of a device (instrument and facility) can be easily upgraded or bugs fixed.

### CROSS REFERENCE OF RELATED APPLICATION

This is a regular application of a provisional application having an application number of 60/269,039 and a filing date of Feb. 14, 2001.

### BACKGROUND OF THE PRESENT INVENTION

1. Field of the Invention

The present invention relates to remote data acquisition and processing. and more particularly to a method for remote control and configuration, and remote system maintenance and upgrading. All data acquisition and processing devices (instruments and facilities) are networked and they communicate/exchange data with each other through the network. Specific functional modules on the smart devices can be remotely upgraded during operational missions, without interrupting other working functional modules on the same device.

2. Description of Related Arts

For aerospace and aeronautics applications, there are generally a great quantity of different devices (instruments and facilities) onboard a space vehicle at different locations. These devices (instruments and facilities) generally come from different manufacturers and with different communication interfaces. Therefore, the information exchange between different devices (instruments and facilities) becomes a problem. Some of the most commonly used communication interfaces and protocols are listed below:

(1) RS-232: RS-232 is one of the first hardware interface for digital data communication. It is currently the most widely used communication interface in data acquisition and processing. Currently almost all personal computers have at least RS-232 port, which is usually simply referred to as serial ports. Most operating system provides support for RS-232 communication, therefore a customer application does not have to write its own device driver. However, it does have some disadvantages, including: 1) Limited Distance—Cable lengths are limited to 50 ft or less. Many will claim to go further, but this is not recommended, and is not part of the RS-232 specification; 2.) Susceptible to Noise - RS-232 is single-ended, which means that the transmit and receive lines are referenced to a common ground; and 3) Not Multi-drop—You can only connect one RS-232 device per port. There are some devices designed to echo a command to a second unit of the same family of products, but this is very rare. This means hat if you have 3 meters to connect to a PC, you will need 3 ports, or at least, an RS-232 multiplexor.

(2) RS-422: RS-422 is similar to RS-232, and can be programmed in the same way. Some advantages of RS-422 are: 1) Long Distance Runs—Up to 500 feet is generally supported, and with repeaters, even further distances can be achieved; 2) Multi-Drop —Usually, up to 32 devices can be connected per port, and even more using repeaters. Devices are distinguished by unique addresses that are assigned to each device. For example, if you have 5 devices attached to a port, they would be addressed as units 1 to 5. If you want to communicate to unit #1, you send a command to unit #1. All units hear the command, but only the addressed unit will respond. The addresses can be set via switches or software, depending on the design of the device. 3) Noise Resistant—Since it uses a separate FLOATING transmit and receive pair (four wires), it offers better noise immunity than RS-232.

(3) RS-485: RS-485 is very similar to RS-422. So much so that it often causes confusion. Both are multi-drop, and both can communicate via very long distances. so then why choose one over the other? First of all, RS-485 is generally a 2-wire system, although some manufacturers may specify 4-wire RS-485, which is far less common and very similar to RS-422. It is important that you identify which one is being employed when considering an instrument. Here are some main differences between 2-wire RS-485 and RS-422: 1) RS-485 can have multiple Commanding Devices and multiple Listening Devices. RS-422 can have only one Commander and multiple Listeners. For example, you can connect one PC (the Commanding device) to 10 temperature controllers (listeners). The PC can instruct any of the controllers to change setpoint, or to send a temperature reading, but none of the controllers can command any of the other controllers. With RS-485, you can have multiple PC's and multiple controllers on one bus, so that one PC can send a command to change a setpoint, and another PC can send a command to send back data, etc. Remember that all devices on the bus must have a unique unit address, so that only the addressed unit will respond. 2) RS-485 wiring is easier since you are only dealing with 2 wires instead of 4. 3) Programming RS-485 is more difficult, since you are sending and receiving on the same two wires you need to enable and disable the transmitter at the correct time so that you may perform proper communications.

(4) Universal Serial Bus (USB): USB is a new standard for connecting PCs to peripheral devices such as printers, monitors and modems. USB offers several advantages over conventional serial and parallel connections, including higher bandwidth (up to 12 Mbits/s) and the ability to provide power to the peripheral device. USB is ideal for data acquisition applications. Since USB connections supply power, only one cable is required to link the data acquisition device to the PC, which most likely has at least one USB port. In addition, the USB's high-speed data transfer (from the data acquisition device to the PC) allows for a real-time display of acquired data, while eliminating the need for expensive memory in the acquisition device. With the backing of Intel, Microsoft, and hundreds of other computer-relatedcompanies, USB is quickly becoming a new universal standard

(5) Ethernet: Ethernet is the IEEE 802.3 series standard, based on the CSMA/CD access method that provides two or more stations to share a common cabling system. This access method, Carrier Sense Multiple Access with Collision Detection, is the basis for Ethernet systems which range from speeds of 1 Mb/s through 1000 Mb/s. The design goals for Ethernet were to create a simply defined topology that made efficient use of shared resources, was easy to reconfigure and maintain, provided compatibility across many manufacturers and systems, while keeping the cost low. The original Ethernet specification began in the early 1970's by Xerox PARC, and was eventually improved upon by Digital Equipment Corporation, Intel, and Xerox (DIX) in 1980 with the release of Ethernet Version 1. By 1982, the specification was updated and Ethernet Version 2 was released. In 1983, Novell created their own proprietary Ethernet frame type prior to the release of the IEEE 802.3 specification (See Section [4.1]). By 1985, the IEEE 802.3 specification was completed and provided a specification for Ethernet connectivity over thick coax and thin coax. In 1990, the specification was updated to include Ethernet over twisted pair copper wiring with 10Base-T. The current IEEE 802.3 specification includes thick coax, thin coax, twisted pair cabling and fiber, with speeds of 10 Mb/s, 100 Mb/s, and 1000 Mb/s.

(6) Token Ring: Token ring is the IEEE 802.5 standard that connects computers together in a closed ring. Devices on the ring cannot transmit data until permission is received from the network in the form of an electronic ‘token’. A token ring network uses a special frame called a token that rotates around the ring when no stations are actively sending information. When a station wants to transmit on the ring, it must capture this token frame. The owner of the token is the only station that can transmit on the ring, unlike the Ethernet topology where any station can transmit at any time. Once a station captures the token, it changes the token into a frame format so data can be sent. High Speed Token Ring, or HSTR, is a new token ring standard that increases the token ring speeds to 100 Mbps and 1 Gbps. The High Speed Token Ring Alliance consists of 3Com, Bay Networks, IBM, Madge, Olicom, UNH Interoperability Lab, and Xylan. The first HSTR specification allows for 100 Mbps token ring speeds over both Type 1 and UTP copper cabling. In 1998, specifications allowing 100 Mbps and 1 Gbps HSTR over fiber were completed by the High Speed Token Ring Alliance.

(7) Infrared Data Association (IrDA): This communication system is created through a web of infrared light. It can only be used in open spaces since it is unable to penetrate walls or any other solid surface.

(8) Digital Enhanced Corless Telecommunications (DECT): Characterized by a “hand over” process that uses two radio links during each connection and selects the best of the two for the communication process. If the portable device moves out of range of the base station the hand over process allows for the range to be increased by allowing the portable device to use another nearby range station.

(9) IEEE 802.11: Use three physical (PHY) layer specifications and one Medium Access Control (MAC) specification. The MAC works in two configurations, one is the “Independent Configuration” and the second is the “Infrastructure Configuration”. The Independent Configuration is an ad-hoc network where stations communicate with one another without infrastructure support. In the Infrastructure Configuration stations communication through access points and their communication scheme creates a wide area coverage. The MAC provides encryption and service scanning. The three PHY include “Frequency Hop Spread Spectrum”, “Direct Sequence Spread Spectrum” and “Baseband IR”. One of its defaults is its very slow frequency hopping rates. In IEEE 802.11b, the PHY layer is extended to provide 5.5 and 11 MB/s, in addition to the 1 and 2 Mb/s data rates.

(10) HOMERF: Strong in the home wireless networking market and based on the specifications created by the HRFWG. HOMERF deals in the market of communications between mobile devices and PC's.

(11) Shared Wireless Access Protocol (SWAP): Able to cany both voice and data traffic. Voice “re-transmission” takes place first. Data packets are transmitted on several links in the middle of the transmission and finally a voice transmission is received at the end. SWAP is designed to be slow cost by using more relaxed radio specifications while maintaining the same frequency-hopping scheme of Bluetooth technology. SWAP is operable as either an add-hoc network or as a managed network.

(12) High Performance Radio Local Area Network (HIPERLAN): HIPERLAN has two specifications, H1 and H2. It works well in building propagation, and high-rate medium range multimedia. Both specifications are expensive to implement.

(13) Bluetooth: Bluetooth wireless technology has several key factors that make it a feasible alternative for Advanced Personal Communicator Prototype. Due to the fact that Bluetooth technology operates within the world wide unlicensed 2.4 GHz spectrum, the Advanced Personal Communicator can be operated anywhere. The purpose of this technology is to operate at a modest range of 10 meters but a power amplifier with a range of about 100 meters can be incorporated. It is a very low cost wireless communication alternative and has very low power requirements since it was designed to run from batteries.

Regardless of the difference in communication interfaces and protocols on different devices (instruments and facilities), there is a demand for accessing the information provided by a device (instrument and facility) from a remote location. There is a further demand for sharing the information provided by a device (instrument and facility) with many other devices (instruments and facilities) at different remote locations. The current technology utilizes protocol converters to convert the input/output of legacy devices into TCP/IP or UDP messages. This fulfills the requirement to access the information from a remote location. However, this technology will not allow multiple devices (instruments and facilities) to share the information provided by one device (instrument and facility) simultaneously.

The present invention provides an innovative way to establish a network with different devices/instruments/facilities. Each device (instrument and facility) sends information to a device server, and the device server forwards the information to the device (instrument and facility) that needs it. Under this scheme, devices (instruments and facilities) with different communication interfaces (protocols or parameters) can communicate with each other. Existing data acquisition and processing or device control and configuration software can also work perfectly under the new structure without any modification.

There is a further demand to upgrade some specific functional modules on a device (instrument and facility) during runtime. For example, for a differential GPS receiver, when new algorithm is available, the user can upgrade the appropriate functional module during runtime without sending it back to the manufacturer. The present invention offers an open architecture, where a user can remotely upgrade specific functional modules on a device (instrument and facility) remotely without interrupting other working functions on the same device. With this innovative architecture, the system maintenance can upgrade can be easily achieved, and this can be done at any time, from any location, even during operational missions.

### SUMMARY OF THE PRESENT INVENTION

A main objective of the present invention is to provide a method and system to implement remote data acquisition and processing, in which all individual units are connected to a central device server. These devices output data to the central device server, and get input from the device server. The central device server acts as a bridge over which the information exchange between different devices are performed. Under this scheme, devices (instruments and facilities) with different communication interfaces (parameters or protocols) can effectively communicate with each other. Existing data acquisition and processing can also work perfectly under the new structure without any modification.

It is a further objective of the present invention to provide a method and system to implement remote data acquisition and processing, in which each device (instrument and facility) supports the unique interface: Java. All functional modules take the form of a Java class, and are highly modularized. By downloading the latest functional module from the manufacturer' web site, the upgrading can be done or bugs can be fixed. The system maintenance and upgrades can be easily achieved, and this can be done at any time, even during operational missions.

It is a further objective of the present invention to provide a method and system to implement remote data acquisition and processing, in which different devices (instruments and facilities) onboard a vehicle can seamlessly cooperate with each other. The architecture of the present invention offers an open, flexible platform, which can integrate the information exchange channels of all these devices and instruments together. This integration is component based and can be easily installed and uninstalled.

It is a further objective of the present invention to provide a method and system to implement remote data acquisition and processing, in which mission module for a specific space flight can be uploaded to the vehicle during flight missions. Upon uploading the mission module, all the information and parameters are installed into the vehicle's command center, which can be used to determine the trajectory, calibrate the guidance system, and backup the related information for that mission.

It is a further objective of the present invention to provide a method and system to implement remote data acquisition and processing, in which the interfaces of the onboard vehicles and instruments form the under layer. The information supplied by these interfaces will be unified into an IP package, and then transmitted back to the ground base server station. In fact, the system structure forms a remote node, which is connected to the Internet. Facilitating the current popular Internet related technologies, the system can easily achieve its reliability and efficiency.

This invention is related to an innovative structure, process, and system for supporting the onboard efficient and reliable information exchange. This invention utilizes the Internet related techniques in an innovative way, which are very popular in many areas of applications, and proved to be commercially successful. The advantages of the present invention include modularization, efficient and reliable information exchange, and compatibility with the current Internet related standards. Leveraging the latest developments of object oriented software engineering, and its widely adopted standards, the present invention is cost-efficient, reliable, maintainable and open to all interfaces which are compatible to Internet standards.

The typical applications of the present invention include: remote data acquisition and processing, remote device control and configuration, remote device diagnose and maintenance, information exchange between devices with different communication interfaces, and simultaneous information sharing between multiple devices.

### BRIEF DESCRIPTION OF THE DRAWINGS

FIG. 1 is a system overview diagram according to a preferred embodiment of the present invention.

FIG. 2 is a block diagram of architecture of a smart device according to the preferred embodiment of the present invention.

### DETAILED DESCRIPTION OF THE PREFERRED EMBODIMENT

The present invention provides a method for remote data acquisition and processing, remote device control and configuration, remote device diagnose and maintenance, information exchange between devices with different communication interfaces, and simultaneous information sharing between multiple devices. The central device server in the present invention provides a common data link, which is responsible for the information exchange between various devices (instruments and facilities) and applications.

In this invention, each onboard instrument supports the unique interface standard: Java. All functional modules take the form of java class, and are modularized. For example, io. coremicro.AGNC may offer I/O driving interface for the coremicro™ IMU. By downloading the latest functional module from the manufacture's web site, the upgrading can be done or bugs can be fixed. The system maintenance and upgrades can easily be achieved, and this can be done at any time, even during the operational flight missions. The present invention is technically compatible with the current commercial applications. The information accumulated by the onboard sensors and instruments is accessible to these commercial applications. And in fact, the onboard instruments and sensors turn into a node of information source in the Internet.

For different mission plans, there are different devices and instruments onboard a vehicle. The present invention offers an open, flexible platform, which can integrate the information exchange channels of all these devices and instruments together. This integration is component based, and can be easily installed and uninstalled.

The platform can even upload the mission module for a specific space flight. Upon uploading the mission module, all the information and parameters are installed into the vehicle's command center, which can be used to determine the trajectory, calibrate the guidance system, and backup the related information for that mission. In the integrated system, the interfaces of the onboard vehicles and instruments forms the under layer. The information supplied by these interfaces will be unified into an IP package, and then transmitted back to the ground base Server station. In fact, the system structure proposed in this project, forms a remote node, which is connected to the Internet world. Facilitating the current popular the Internet related techniques, the system can easily achieve its reliability and efficiency.

The present invention includes the following steps:

1) Create a data link between the system administrator and the central device through an appropriate communication media. The data link creation follows the defined administrator-server communication mechanism.

2) Creating a data link between individual devices (instruments and facilities) and the central device server. The data link creation follows the defined device-server communication mechanism.

3) Creating a data link between devices (instruments and facilities) via the central device server where information exchange is needed. The data link creation follows the defined device-device communication mechanism.

4) The central device server receives data from both communicating parties, and forwards the output stream of one device (instrument and facility) to the input stream of the other, and vise versa.

5) The central device server is responsible for the flow control of the communication system, including package buffering and management, package recognition and distribution, and communication status monitoring.

6) To update a specific functional module on a specific device (instrument and facility), the central device server connects to the manufacturer's web site through an appropriate communication media, retrieves the specific package, and installs the package onto the target device (instrument and facility).

7) To perform remote data acquisition and processing, a user creates a data link with the central device server through an appropriate communication media and requests data from a specific device (instrument and facility). The central device server redirects the output stream of the device (instrument and facility) to the input stream of the user.

8) To perform remote device control and configuration, a user creates a data link with the central device server through an appropriate communication media and requests data from a specific device (instrument and facility). The central device server redirects the output stream of one device (instrument and facility) to the input stream of the user, and vise versa.

9) To convert onboard devices into nodes of information source on the Internet, the central device is connected to the Internet through an appropriate communication media and assigned an IP address. Different devices (instruments and facilities) are bounded to different port numbers on the central device server. Therefore, commercial application on the Internet can access the information provided by these devices (instruments and facilities) by sending a request to the central device server with the specific port numbers.

The communication media between the central device server and the remote control terminal (Internet and commercial applications) can be different. Therefore the mechanism of information between the central device server and the remote control terminal (Internet and commercial applications) can be different. Several of the appropriate communication media include RS-232, RS-422, RS-485, USB, Ethernet, Token Ring, IrDA, DECT, HOMERF, SWAP, HIPERLAN, and Bluetooth.

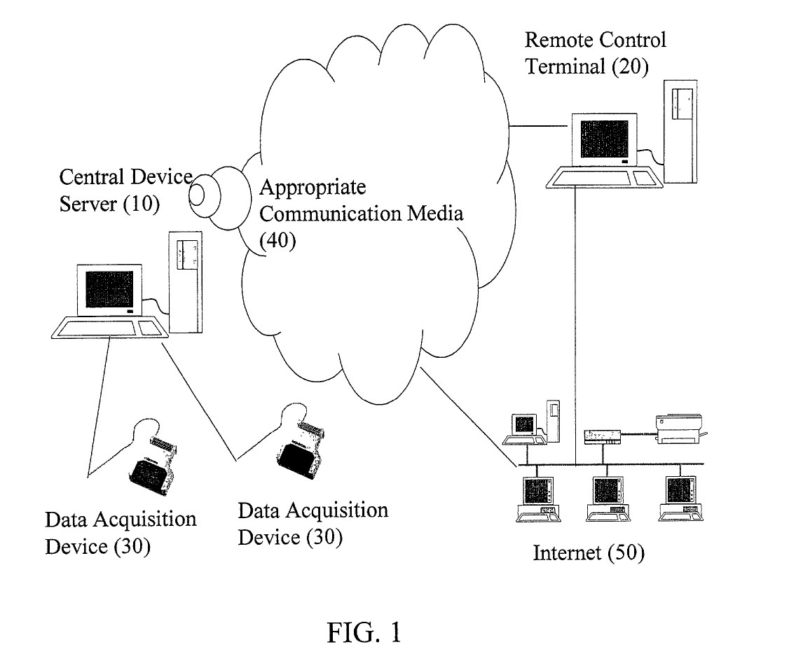

As shown in FIG. 1, the information exchange system of current invention comprises of a central device server 10, a remote control terminal 20, two data acquisition devices 30, an appropriate communication media 40, and the Internet 50. The central device server acts as a bridge, which connects the remote control terminal, various devices (instruments and facilities), the Internet, and various commercial applications. A device (instrument and facility) can request data from another device (instrument and facility) through the central device server. By connecting to the central device server through an appropriate communication media, a user can control and configure a device (instrument and facility) remotely, or acquire and process the information accumulated by the device (instrument and facility) remotely. By connecting the central device server to the Internet, the devices (instruments and facilities) connected to the central device server can be turned into nodes of information source on the Internet and can be accessible via the Internet.

To create a data link between the remote control terminal and the central device server, the following procedure should be followed:

(1) Call the appropriate device driver to communicate with the appropriate communication hardware.

(2) Create a socket through the selected communication media with the appropriate address and port number.

(3) The central device server issues a request to verify the identity of the communication party, for example, a login name and password.

(4) Submit the personal identification information to the central device server for approval.

(5) The data link is successfully established.

The communication media between the central device server and devices (instruments and facilities) can be different. Therefore the mechanism of information between the central device server and devices (instruments and facilities) can be different. Several of the appropriate communication media (protocol) include RS-232, RS-422, RS-485, USB, Ethernet, Token Ring, IrDA, DECT, IEEE 802.11, HOMERF, SWAP, HIPERLAN, and Bluetooth.

To create a data link between a specific device (instrument and facility) and the central device server, the following procedure should be followed:

(1) The system administrator issues an instruction to the central device server through an appropriate data link. The instruction contains the type and address of the hardware interface the specific device (instrument and facility).

(2) The central device server calls the appropriate device driver to initiate a connection to the specific device (instrument and facility).

(3) The central device server adds the specific device (instrument and facility) to its device list when the connection is successfully.

(4) The data link is successfully established.

When connected to the central device server, the input stream and output stream of the devices (instruments and facilities) are controlled by the central device server. Therefore, the information exchange between different devices (instruments and facilities) can be considered as the inter process communication within the central device server, which is a lot easier than communication between different hardware interfaces. To create a data link between two specific devices (instruments and facilities), the following procedure should be followed:

(1) The system administrator issues an instruction to the central device server through an appropriate data link. The instruction contains the type and address of the hardware interface the specific devices (instruments and facilities).

(2) The central device server checks out the input stream and output stream of the specific devices (instruments and facilities) from its device list.

(3) The central device server redirects the input stream and output stream of the specific devices (instruments and facilities) to each other.

(4) The data link is successfully established.

It is a further objective of the present invention to provide a method and system to implement remote data acquisition and processing, in which each device (instrument and facility) supports the unique interface: Java. All functional modules takes the form of Java class, and are highly modularized. By downloading the latest functional module from the manufacturer web site, the upgrading can be done or bugs can be fixed. The system maintenance and upgrades can be easily achieved, and this can be done at any time, even during operational missions.

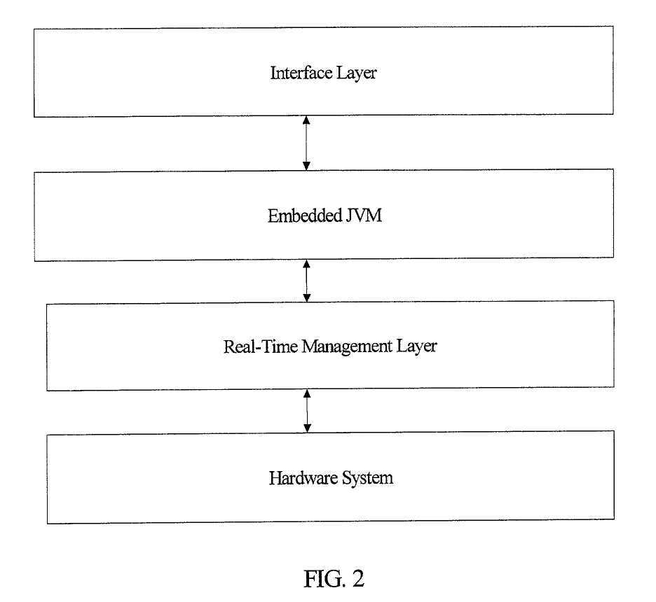

Referring to FIG. 2, a smart device (instrument and facility) as mentioned above generally consists of 4 layers. The Hardware layer and Real Time Management layer are employed to perform the instrument's functions. The Embedded JVM layer offers a support environment for the Interface layer. An Interface layer supplies a connection point (in the form of Java Class) with the central device server. When such an instrument is installed, the central device server can easily build a connection to it. The connection is based on Java technique. and can be easily transplanted. maintained. and upgraded.

The hardware system (31) of a smart device includes a data processor, memory, storage facilities, and communication peripherals. For example, a smart GPS receiver might have an antenna, while a smart thermometer might be equipped with a thermometer.

The real time management layer (32) of a smart device is equivalent to the operating system on a desktop computer. This can be the real-time operating system (RTOS) provided by the manufacturer of the data processor, or a general-purpose embedded operating system such as Windows CE, VxWorks, and QNX.

The embedded JVM (33) offers a support environment for the interface layer (34). Currently there are many versions of a Java Virtual Machine. Though they all stem from Sun Microsystem's release of The Java Virtual Machine Specification and The Java Language Specification, different versions of JVM focus on their different spots. Some may optimize its 2-dimension or 3-dimension at graphics performance; some may highlight a byte-code compiler. The most important factor in our selection is that the JVM must be easily modified to cooperate with the software supporting environment of the instruments in general. Our focus also falls on the communication capability, bytecode compiler, and minimum requirements in resources. There are several candidates that can be used on a smart device, including the Sun Microsystem's JVM, Wind River Systems PersonalJava™ environment, and QNX Software Systems' EmbeddedJave™. The first is the provider of the Java industry standard; and the others are experienced RTOS related products providers. VxWorks and QNX are their main products.

The interface layer (34) of a smart device contains the core functional modules that performs specific data acquisition and processing functions. These functional modules take the form of standard Java classes or C/C++ DLL's. These functional modules can be called by the embedded JVM (33) to perform specific data acquisition and processing functions. They can also be overwritten by system upgrading functions with the new functional modules.

With the above-mentioned architecture, the function of a device (instrument and facility) can greatly expanded during runtime. For example, for a differential GPS receiver, it can be modified to operate as a radio, providing that the frequency of the radio signal is within the passband of the GPS receiver. When new algorithm is available the user can upgrade the GPS receiver to use the new functional module for more accurate positioning information, without sending the receiver back to the manufacturer. If there are more than one functional module running on the GPS receiver, the upgrading process will not interrupt the operation of other functional modules.

A smart device (instrument and facility) as described above has two operational modes, one is data acquisition mode and the other is control mode. In data acquisition mode, the device (instrument and facility) performs its normal designed operation and sends real-time data to the central device server for information sharing. In control mode, the central device server controls the operation of the device (instrument and facility). Generally, special maintenance functions such as device control and configuration, functional module upgrading, and emergency processing are implemented in control mode, where the central device server has complete control over the specific device (instrument and facility).

There are two methods to create a functional module that can be upgraded during runtime. These methods include:

(1) C/C++ DLL Solution: The functional module that needs to be upgraded during runtime is encapsulated in a dynamic linked library (DLL) file. The main program uses the LoadLibrary( ) function to load the DLL and call the appropriate functional module. To upgrade the functional module, the main program first stops the running functional module, and uses the FreeLibrary( ) function to unload the DLL. After that the central device server installs the new DLL file to the appropriate directory, and the main program uses the LoadLibrary( ) function to load the new DLL and call the upgraded functional module.

(2) Java Class Loader Solution: In Java programming language, the function of a class loader is similar to that of the LoadLibrary( ) method in C/C++. The functional module that needs to be upgraded during runtime can be either a subclass of a base class or an implementation of an interface. Both the base class and interface were known to the compiler during compile time, but the subclass and the implementations were not. Since the base class and the interface define the functions (methods) to be called during runtime, the JVM can call the subclass and implementations at runtime.

To upgrade a specific functional module on a specific device (instrument and facility), the following procedure should be followed:

(1) The system administrator issues an instruction to the central device server through an appropriate data link. The instruction contains name of the device and the functional module to be upgraded.

(2) The central device server performs a query in its database for an instructions to carry out the upgrade.

(3) According to the instructions given by the query result the central device server connects to the manufacturer's web site (or other upgrading hosts) through an appropriate communication media.

(4) According to the instructions given by the query result, the central device server retrieves the appropriate upgrading package from the manufacturer's web site (or other upgrading hosts).

(5) The central device server sends and instruction to the specific device (instrument and facility) through the data link to stop the currently running functional module.

(6) According to the instructions given by the query result the central device server transfers the package retrieved from the manufacturer's web site (or other upgrading hosts) to the device (instrument and facility) through the data link and save it at the appropriate place. This operation will over-write the existing functional module on the device (instrument and facility).

(7) According to the instructions given by the query result, the central device server sends an command to the device (instrument and facility) through the data link to start the new functional module.

(8) The new functional module is successfully installed.

The functions which the central device server is expected to perform include package buffering and management, package recognition and distribution, communication status monitoring, component loading and unloading mechanism, and component online upgrading. The central device server has several operational states: the modular uploading state, modular installation/ un-installation state, real time data transmission state, security monitoring state, and system error handling state. All these states are transformable from one into another or more at some specific events triggering. There are two categories of data streams in the central device server, one is the real time measurement data and the other is status monitoring data. The first one requires wide bandwidth, but has lower priority; the other one, on the contrary, has the higher priority but requires only a small portion of the communication bandwidth.

In the current invention, the central device server utilizes a message manager to control the information exchange between the server, devices, and control center. The message manager utilizes an array of queues with different priority values. When processing a incoming message, the message manager follows the following procedure:

(1) Buffer all messages in an array of message queues according to message type (priority).

(2) Sort all the message queues according to message type (priority)

(3) Process each message queue according to their priority.

(4) Process each message in a message queue in a First In First Out (FIFO) manner.

What is claimed is:

1. A implement remote data acquisition and processing method, comprising the steps of:
(a) creating a data link between the system administrator and the central device through an appropriate communication media, wherein the data link creation follows the defined administrator-server communication mechanism;
(b) creating a data link between individual devices (instruments and facilities) and the central device server, wherein the data link creation follows the defined device-server communication mechanism;
(c) creating a data link between devices (instruments and facilities) via the central device server where information exchange is needed, wherein the data link creation follows the defined device-device communication mechanism;
(d) receiving data by the central device server data from both communicating parties, and forwarding the output stream of one device (instrument and facility) to the input stream of the other, and vise versa;
(e) being responsible by the central device server for the flow control of the communication system, including package buffering and management, package recognition and distribution, and communication status monitoring;
(f) updating a specific functional module on a specific device (instrument and facility), the central device server connects to the manufacturer's web site through an appropriate communication media, retrieves the specific package, and installs the package onto the target device (instrument and facility);
(g) performing remote data acquisition and processing, a user creates a data link with the central device server through an appropriate communication media and requests data from a specific device (instrument and facility), wherein the central device server redirects the output stream of the device (instrument and facility) to the input stream of the user;
(h) performing remote device control and configuration, a user creates a data link with the central device server through an appropriate communication media and requests data from a specific device (instrument and facility), wherein the central device server redirects the output stream of one device (instrument and facility) to the input stream of the user, and vise versa; and
(i) converting onboard devices into nodes of information source on the Internet, wherein the central device is connected to the Internet through an appropriate communication media and assigned an IP address. Different devices (instruments and facilities) are bounded to different port numbers on the central device server, therefore, commercial application on the Internet can access the information provided by these devices (instruments and facilities) by sending a request to the central device server with the specific port numbers.

2. The method, as recited in claim 1, wherein the step (a) further comprises the steps of:
(a1) calling the appropriate device driver to communicate with the appropriate communication hardware;
(a2) creating a socket through the selected communication media with the appropriate address and port number;
(a3) issuing by the central device server a request to verify the identity of the communication party, for example, a login name and password;
(a4) submitting the personal identification information to the central device server for approval; and
(a5) successfully establishing the data link.

3. The method, as recited in claim 2, wherein the step (b) further comprises the steps of:
(b1) issuing by the system administrator an instruction to the central device server through an appropriate data link, wherein the instruction contains the type and address of the hardware interface the specific device (instrument and facility);
(b2) calling by the central device server the appropriate device driver to initiate a connection to the specific device (instrument and facility);
(b3) adding by the central device server the specific device (instrument and facility) to its device list when the connection is successfully; and
(b4) establishing the data link successfully.

4. The method, as recited in claim 3, wherein the step (c) further comprises the steps of:
(c1) issuing by the system administrator an instruction to the central device server through an appropriate data link, wherein the instruction contains the type and address of the hardware interface the specific devices (instruments and facilities);
(c2) checking out by the central device server the input stream and output stream of the specific devices (instruments and facilities) from its device list;
(c3) redirecting by the central device server the input stream and output stream of the specific devices (instruments and facilities) to each other; and
(c4) establishing the data link successfully.

5. The method, as recited in claim 4, wherein the devices (instruments and facilities) support the unique interface: Java.

6. The method, as recited in claim 5, where certain functional module on the devices (instruments and facilities) can be upgraded during runtime.

7. The method, as recited in claim 6, where the functional module to be upgraded during runtime can be implemented with either C/C++ dynamic linked library or Java class loader.

8. The method, as recited in claim 7, further comprising the following steps for upgrading a functional module during runtime:
(8.1) issuing by the system administrator an instruction to the central device server through an appropriate data link, wherein the instruction contains name of the device and the functional module to be upgraded;
(8.2) performing the central device server a query in its database for an instructions to carry out the upgrade;
(8.3) according to the instructions given by the query result, connecting the central device server to the manufacturer's web site (or other upgrading hosts) through an appropriate communication media;
(8.4) according to the instructions given by the query result, retrieving by the central device server the appropriate upgrading package from the manufacturer's web site (or other upgrading hosts);
(8.5) sending the central device server and instruction to the specific device (instrument and facility) through the data link to stop the currently running functional module;
(8.6) according to the instructions given by the query result, transferring by the central device server the package retrieved from the manufacturer's web site (or other upgrading hosts) to the device (instrument and facility) through the data link and save it at the appropriate place, wherein the operation over-writes the existing functional module on the device (instrument and facility);
(8.7) according to the instructions given by the query result sending by the central device server a command to the device (instrument and facility) through the data link to start the new functional module; and
(8.8) installing a new functional module successfully.

9. The method, as recited in claim 8, wherein the central device server utilizes a message manager to control the information flow.

10. The method, as recited in claim 9, wherein message manager follows the following steps in managing the information exchange process:
(10.1) buffering all messages in an array of message queues according to message type (priority);
(10.2) sorting all the message queues according to message type (priority):
(10.3) processing each message queue according to their priority; and
(10.4) processing each message in a message queue in a First In First Out (FIFO) manner.
